(19) United States
(12) Patent Application Publication
(10) Pub. No.: US 2015/0023615 A1
(43) Pub. Date: Jan. 22, 2015

(54) MOUNTABLE HOLDING BAG FOR AN EXTENSION LADDER STABILIZER

(71) Applicant: Kristopher Jon Warren, Jacobus, PA (US)

(72) Inventor: Kristopher Jon Warren, Jacobus, PA (US)

(21) Appl. No.: 14/299,929

(22) Filed: Jun. 9, 2014

Related U.S. Application Data
(60) Provisional application No. 61/857,194, filed on Jul. 22, 2013.

(51) Int. Cl. E06C 7/14; B65D 33/14

(52) U.S. Cl. CPC E06C 7/14; B65D 33/14
USPC 383/22

(57) ABSTRACT

A removably attachable stabilizer holding bag which can be attached to a stabilizer bar of a ladder having a bag body, an attachment mechanism disposed on the top side of the bag body, and a shoulder strap attached to the attachment mechanism. The bag body is a hollow rectangular structure, the attachment mechanism is defined primarily by a fitted collar and attachment straps which engage ladder stabilizer bars. The shoulder strap is adapted to allow the stabilizer holding bag to be supported by a user's shoulder. This structure allows the stabilizer holding bag to hold tools and materials, be carried up and down a ladder without the use of hands, and be mounted on a ladder stabilizer bar for ease of access at the top of a ladder by a user.

### CROSS REFERENCE TO RELATED APPLICATIONS

This application claims the benefit of and incorporates by reference co-pending U.S. provisional patent application Ser. No. 61/857,194 filed Jul. 22, 2013.

### BACKGROUND OF THE INVENTION

1. Field of the Invention

This invention relates generally to tool accessories and, more particularly, to a removably attachable holding bag for an extension ladder stabilizer.

2. Description of the Prior Art

The use of ladders to gain access to elevated areas is well known and dates back at least 10,000 years. A common type of ladder is a rigid ladder, which is designed to be leaned against a vertical surface, commonly at an angle, to allow a user to climb up to access something on or near the vertical surface. On type of rigid ladder is an extension ladder, which is a fixed ladder having two or more portions which can be retracted together for storage and also extended for longer reach. Rigid ladders typically comprise a series of rungs fixedly disposed between a pair of rails in a manner which allows the user to ascend (or descend) the ladder by engaging the rungs sequentially. Usually, because of the angle at which a rigid ladder is placed on the vertical surface to be climbed a user must use their hands and feet to move in the desired direction on the ladder. A ladder stabilizer (or stabilizer bar), which is a structure adapted to attach at or near the top of a rigid extension ladder and provide additional contact points with the vertical surface on which the ladder rests, is often incorporated when the ladder is used to work around windows, eaves and high walls.

A problem created by the need for the user to use both his hands and feet to move up and down a ladder is that it is commonly very difficult and/or unsafe to transport tools and material up or down a ladder as well as use hold a plurality of tools and materials at or near the top of a ladder. Thus, there remains a need for a removably attachable stabilizer holding bag which would allow a user to easily and safely hold tools and materials while being carried up and down a ladder and also while in position at the top of the ladder. It would be helpful if such a stabilizer holding bag included attachment mechanism adapted to attach to existing ladder stabilizers. It would be additionally desirable for such a stabilizer holding bag to include a strap which allows a user to hold it without the use of the user's hands.

The Applicant's invention described herein provides for a holding bag adapted to be removably attached to a ladder stabilizer. The primary components of Applicant's removably attachable stabilizer holding bag are a base bag, an attachment mechanism permanently attached to said base bag, and a shoulder strap. When in operation, the stabilizer holding bag allows a user to transport tools and materials up and down a ladder while maintaining the full use of the user's hands as well as store tools and materials at the top of a ladder. As a result, many of the limitations imposed by the prior art are removed.

### SUMMARY OF THE INVENTION

A removably attachable stabilizer holding bag for providing a structure in which tools and materials can be securely stored at the top of a ladder as well as transported up and down a ladder without the use of hands. The removably attachable stabilizer holding bag has a bag body providing a container means, an attachment mechanism disposed on the top side of the bag body providing a means for attaching, and a shoulder strap attached to the attachment mechanism providing a carrying means. The bag body is defined by a durable bag having a hollow rectangular shape and constructed of a leather or canvas material. The attachment mechanism is defined primarily by a fitted collar and attachment straps which engage ladder stabilizer bars. The shoulder strap is adapted to allow the stabilizer holding bag to be supported by a user's shoulder. This structure allows the stabilizer holding bag to hold tools and materials, be carried up and down a ladder without the use of hands, and be mounted on a ladder stabilizer bar for ease of access at the top of a ladder by a user. In addition, the structure of the stabilizer holding bag allows it to be used to collect any type of debris when in use.

It is an object of this invention to provide a removably attachable stabilizer holding bag which would allow a user to easily and safely hold tools and materials while being carried up and down a ladder and also while in position at the top of the ladder.

It is another object of this invention to provide a stabilizer holding bag which includes an attachment mechanism adapted to attach to existing ladder stabilizers.

It is yet another object of this invention to provide a stabilizer holding bag which included a strap which allows a user to hold it without the use of the user's hands.

These and other objects will be apparent to one of skill in the art.

### BRIEF DESCRIPTION OF THE DRAWINGS

FIG. 1 is a perspective view of the top of an extension ladder having an attached ladder stablilizer.

FIG. 2 is a side elevational view of a removably attachable stabilizer holding bag built in accordance with the present invention.

FIG. 3 is a side elevational view of a removably attachable stabilizer holding bag built in accordance with the present invention attached to an extension ladder having an attached stabilizer bar.

### DETAILED DESCRIPTION OF THE INVENTION

Referring now to the drawings and in particular FIG. 1, a conventional extension ladder with stabilizer assembly 10 is shown with a view of the top of an extension ladder 11 connected to a stabilizer bar 12. The stabilizer bar 12 is shown as a three sided bar with two docking ends 12a.

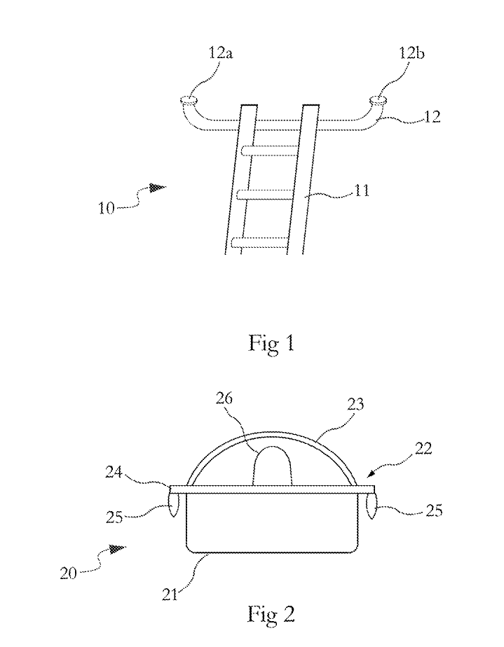

Referring now to FIG. 2, a removably attachable stabilizer holding bag 20 is shown having a bag body 21, an attachment mechanism 22 disposed on the top side of the bag body 21, and a shoulder strap 23 attached to the attachment mechanism. The bag body 21 is defined by a durable bag having a hollow rectangular shape and constructed of a leather or canvas material. In the preferred embodiment, the bag body 21 has a bottom surface and a top lid, which are connected to opposing ends of a front surface, back surface, left surface and right surface with dimensions which measure four feet long (from the left surface to the right surface), ten inches wide (from the front surface to the back surface), and twelve inches deep from the bottom surface to the top lid.

Attached to the top lid of the bag body is the attachment mechanism 22. The attachment mechanism 22 is defined by a fitted collar section 24 having a rectangular shape which extends outwardly beyond the top lid of the bag body 21, four attachment straps 25 disposed substantially at each corner of the fitted collar section 24 (the front two are shown), and a hood portion 26. The shoulder strap 23 extends above the attachment mechanism 22 and is defined as a durable material attached to the bag body 11 and the attachment mechanism 22 at least two points. In the preferred embodiment, the shoulder strap 23 is attached at two points along the top lid and allows a user to pass their arm through the strap in a manner to allow the user's shoulder to engage the strap so that the weight of the stabilizer holding bag 20 can be transferred to the user's shoulder. The hood portion 26 is defined by a hood shaped structure which extends up from the top lid that is sized to receive the top of the extension ladder 11 to provide additional support for the stabilizer holding bag 20.

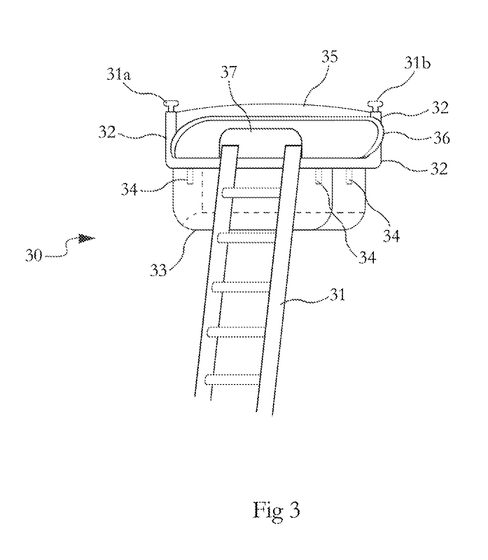

Referring now to FIG. 3, the stabilizer holding bag 30 is shown attached to a stabilizer bar 31a of an extension ladder 31. When the stabilizer holding bag 30 is in place over the stabilizer bar 31a, most of the stabilizer bar 31a is no longer visible because the fitted collar section 32 is placed over the three sided bar structure of the stabilizer bar 31a, extending almost to its docking ends 31b. The bag body 33 extends downward from the fitted collar section 32 and can receive and hold tools and materials as desired by the user. The attachment straps 34 are defined by fabric hook and loop fastening straps in the preferred embodiment which assist the fitted collar section 32 in holding the stabilizer holding bag 30 in place on the stabilizer bar 31a. The top lid 35 includes a zipper about a portion of its perimeter to allow the stabilizer holding bag 30 to be opened and closed by way of a zipper. The shoulder strap 36 connects to the fitted collar section 32 and the bag body 33 at the front side, closest to the ladder 31. The hood portion 37 receives the top of the ladder 31 to extend above the stabilizer holding bag 30.

In one embodiment, when the stabilizer holding bag is placed on the stabilizing bar of a ladder, the shoulder strap is flipped over the ladder to provide an additional securing mechanism for the stabilizer holding bag on the ladder.

It is contemplated that the stabilizer holding bag built in accordance with the present invention may be additionally configured with a disposable plastic liner sized to fit the interior of the stabilizer holding bag.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A stabilizer holding bag for attaching to a stabilizer bar of a ladder, comprising:
a bag body defined by a structure having a bottom surface and a top lid, wherein said bottom surface and top lid are connected to opposing ends of a front surface, back surface, left surface and right surface; and
an attachment mechanism attached around the perimeter of the bag body, wherein said attachment mechanism is configured to secure the bag body to the stabilizer bar of a ladder;

2. The stabilizer holding bag for attaching to a stabilizer bar of a ladder of claim 1, wherein said attachment mechanism is defined by a fitted collar section extending around the perimeter of the bag body and at least one attachment strap disposed on the fitted collar.

3. The stabilizer holding bag for attaching to a stabilizer bar of a ladder of claim 2, additionally comprising a shoulder strap defined by a contiguous structure having a first end and a second end which are both attached to the bag body.

4. The stabilizer holding bag for attaching to a stabilizer bar of a ladder of claim 2, wherein four attachment straps are disposed on said fitted collar.

5. The stabilizer holding bag for attaching to a stabilizer bar of a ladder of claim 2, wherein said attachment mechanism additionally includes a hood portion adapted to receive the top of a ladder.

6. A stabilizer holding bag for attaching to a stabilizer bar of a ladder, comprising:
a container means for holding tools or debris; and
a means for attaching said container means to a ladder.

7. The stabilizer holding bag for attaching to a stabilizer bar of a ladder of claim 6, additionally comprising a carrying means for transporting said stabilizer holding bag.

8. A stabilizer holding bag for attaching to a stabilizer bar of a ladder, comprising:
a bag body defined by a rectangular structure having a bottom surface and a top lid, wherein said bottom surface and top lid are connected to opposing ends of a front surface, back surface, left surface and right surface;
an attachment mechanism attached around the perimeter of the bag body, wherein said attachment mechanism is defined by a fitted collar section extending around the perimeter of the bag body, four attachment straps disposed on the fitted collar, and a hood portion adapted to receive the top of a ladder;
wherein said fitted collar section is adapted to be secured to a conventional stabilizer bar; and
a shoulder strap defined by a contiguous structure having a first end and a second end which are both attached to the bag body.
